(19) United States
(12) Patent Application Publication
(10) Pub. No.: US 2018/0094591 A1
(43) Pub. Date: Apr. 5, 2018

(54) CIRCUIT FOR TEMPERATURE COMPENSATION

(71) Applicant: EAGLE ACTUATOR COMPONENTS GMBH & CO. KG, Weinheim (DE)

(72) Inventors: Ralf Heinrich, Schwegenheim (DE); Daniel Koch, Edingen-Neckarhausen (DE); Diether Hoppner, Mannheim (DE)

(73) Assignee: EAGLE ACTUATOR COMPONENTS GMBH & CO. KG, Weinheim (DE)

(21) Appl. No.: 15/300,814

(22) PCT Filed: Mar. 24, 2015
(86) PCT No.: PCT/EP2015/000627

§ 371 Date: Sep. 30, 2016

(30) Foreign Application Priority Data
Apr. 24, 2014 (DE) 10 2014 005 809.3

(51) Int. Cl. F02D 9/10; F02D 11/10; H01F 7/18; G01F 1/688

(52) U.S. Cl. CPC F02D 9/1065; G01F 1/6888; H01F 7/1838; F02D 11/10

(57) ABSTRACT

The present disclosure is directed to a circuit for use in actuators, electromotive drives and valves. The circuit includes an electric conductor having a temperature-dependent resistance. The electric conductor includes a coil having a copper wire wound over a coil support. The electric conductor is connected in series with an electrical series resistor, which includes a non-reactive resistor connected in parallel with an NTC resistor. The non-reactive resistor is a wire that is composed of an alloy of copper, nickel and manganese. The wire is wound over the coil. The wire may be wound on an area of the coil support separate from the copper wire. The construction of the circuit minimizes the affect of temperature on the operation of the circuit.

### CROSS-REFERENCE TO RELATED APPLICATION

This application is the U.S. national phase of PCT Application No. PCT/EP2015/000627 filed on Mar. 24, 2015, which claims priority to German Patent Application No. 10 2014 005 809.3 filed on Apr. 24, 2014, the disclosures of which are incorporated in their entirety by reference herein.

### TECHNICAL FIELD

The invention relates to a circuit for use in actuators, electromotive drives or valves.

### BACKGROUND

DE 100 17 661 C2 discloses a circuit, in which a coil is series-connected with a temperature-dependent NTC-resistor. In this way, a variation of electrical resistance of coil due to temperature influences may be contrasted. It is also already known to use electrical circuits in valves for compensation of temperature influences.

Such a circuit is disclosed in DE 196 46 986 A1.

The disclosed valves are preferably used on motor vehicles and are provided with electromagnetic coils, which may be operated in a timed way. Such coils actuate metallic rotors by means of magnetic forces. The metallic rotors close or open sealing seats, in order to allow or avoid a flow of material through a conduit.

The magnetic force of a coil is a function of the electric current. In case of voltage-controlled operation of the coil, the current depends on the electric resistance of its wound wire. With increasing temperature, the electric resistance rises, so that the current is reduced and the magnetic force of the coil is weakened.

Since these valves are often mounted into the motor room of motor vehicles, depending on ambient and operating conditions, very different ambient temperatures are present, which influence the electric resistance of the coil's wire.

In order to avoid this, DE 196 46 986 A1 proposes to operate a primary and a secondary coil.

The secondary coil is series-connected with a temperature-dependent NTC-resistor, whose electric resistance decreases with an increase in temperature. In this way the voltage on the secondary coil is increased and its magnetic force is strengthened.

The secondary coil may compensate, through its increasing magnetic force, the magnetic force of the primary coil, which falls with an increase in temperature.

In this case it is disadvantageous that the valve is provided with two coils, which have to be wound and adequately mounted. This causes a complex apparatus related construction.

FR 2 893 756 A1 discloses an assembly, in which a temperature-independent resistor is parallel-connected with an NTC-resistor and both resistors form a series resistor. Both resistors are housed within a device, which is provided with a basis body of plastic material and a cover with contact flaps. A coil may be connected to this device, in order to be series-connected with the series resistor.

The bulky temperature-independent resistor is inserted in a cavity of the basis body. This device occupies a relatively large space and is also constructively relatively complex. It's application in valves, especially in compact valves, is therefore limited.

The present disclosure therefore discloses a circuit, with which the influence of temperature on an electric conductor can be minimized with a simple design.

### SUMMARY

The present disclosure provides a circuit for use in actuators, electromotive drives and valves. The circuit includes an electric conductor having a temperature-dependent electric resistance. The electric conductor is series-connected with an electric series resistor that includes a parallel circuit having a non-reactive resistor and an NTC resistor. The non-reactive resistor is formed exclusively or predominantly by a wire. The present disclosure also provides a valve having the circuit. In the valve, the electric conductor is an electromagnetic coil. The valve further includes a rotor that moves when electricity is provided to the electromagnetic coil.

### BRIEF DESCRIPTION OF THE DRAWINGS

FIG. 1 is a circuit, in which a coil is series-connected with a parallel circuit formed by a non-reactive resistor and an NTC-resistor,

FIG. 2 is a schematic representation of a valve, in which the circuit of FIG. 1 is provided,

FIG. 3 is a diagram, in which the temperature dependence of the electric resistor of the coil and of the total resistance formed by coil and parallel circuit is shown,

FIG. 4 is a schematic illustration of a coil, on which, in addition to a copper wire, a wire of Constantan is wound, wherein the copper wire and the Constantan wire on the coil are electrically insulated from each other, and

FIG. 5 shows a schematic illustration of a coil, on which, in addition to a copper wire, a wire of Constantan is wound, wherein the copper wire and the Constantan wire are positioned in different winding areas.

### DETAILED DESCRIPTION

According to the disclosure, a non-reactive resistor is exclusively or predominantly provided by a wire. The resistance of a wire may be readily adjusted by changing its length. A wire is also a cheaper, lighter and less bulky resistor. A wire may be integrated into a circuit without occupying much space, wherein the circuit comprises an electric conductor with a temperature-dependent electric resistor, which is series-connected with an electric series resistor, wherein the electric series resistor comprises a parallel circuit comprised of a non-reactive resistor and an NTC-resistor (hot conductor). It has been recognized that by means of a parallel connection of a purely non-reactive resistor, which is formed by a wire, and an NTC-resistor, it is constructively easy to provide a compensation of a temperature-dependent change of resistance of a conductor. The increase of the electric resistance of the conductor is compensated by a reduction of the electric resistance of the series resistor. In this way it is possible that the total resistance formed by the electric conductor and the series resistor may be approximately kept at a constant level throughout a certain temperature range. In this way a temperature independent operating current is achieved in voltage-controlled components. In this sense a compact circuit is provided, with which the influence of temperature on an electric conductor may be minimized by using a simple design.

The wire may have a specific electric resistance, whose value at 600° C. is less than 20%, preferably less than 10%, and in particular preferably less than 5% higher than its value at 20° C. In this way, the electric resistance of the non-reactive resistor is almost temperature independent.

The wire may be manufactured using Constantan or may comprise Constantan. Constantan is an alloy whose specific electric resistance is eminently temperature independent. Constantan is also a trademark. It defines an alloy, which usually contains approximately 53-57% copper, approximately 43-45% nickel and approximately 0.5-1.2% manganese. This alloy is provided with an approximately constant specific electric resistance over wide temperature ranges.

The wire may additionally be wound over a coil, which, as an electric conductor, is provided with the temperature-dependent electric resistance. In this way the wire may be positioned into the circuit without occupying much space. Moreover, the wire contributes to the magnetic field of the coil and may even strengthen it. The wire may be wound under, over or beside a copper wire of the coil, if, on the coil, it is only electrically insulated from the latter.

In this context, the wire may be additionally wound over a coil support, which exhibit, as an electric conductor, the temperature-dependent electric resistance, wherein the wire is positioned in its own winding area. The wire, preferably a constantan wire, is not applied as an additional layer over copper wire windings, for example, but is provided with its own winding area on the coil support.

The electric conductor may be provided with a copper wire. Due to the series resistor, the temperature-related resistance change of copper may be compensated very well. This effect may be used with all electromotive actuators whose operation is voltage-controlled instead of current-controlled.

Concretely, it is conceivable that not only valves, but also other linear drives, motors and other actuators are provided with the present circuit. In this context, the present circuit may therefore be used in an actuator, an electromotive drive or in a valve.

More preferably, a valve may comprise a circuit of above said kind. The valve may comprise, as an electric conductor, an electromagnetic coil and a rotor, wherein the rotor, in case of electrification of the coil, may be driven by the magnetic force of the coil and wherein the coil is series-connected with an electric series resistor. It may be foreseen that the electric series resistor comprises a parallel circuit formed by a non-reactive resistor and an NTC-resistor. Due to the parallel-connection of a purely non-reactive resistor and an NTC-resistor, a compensation of a temperature-related resistance change of coil may be obtained.

Advantageously, between 0 and 140° C. a resistance change of coil may be very well compensated, wherein the temperature range may be modified by a suitable selection of components of the series resistor. The electric resistance of the coil increases in this temperature range almost linearly, whereas the total resistance of the series connection of coil and series resistor remains almost constant in this temperature range. The increase of the electric resistance of the coil is compensated by the reduction of electric resistance of the series resistor. In the end, the total resistance is approximately constant, so that the resulting coil current remains constant without any significant loss of magnetic force of coil. Due to the use of only two electric components for the series resistor, a valve is provided, in which the influence of temperature on the magnetic force of coil is as low as possible, wherein the valve is provided with as few as possible electric components.

Only one coil may be provided. In this way, a design with few components is ensured. Complex winding operations on various coils are avoided.

The valve may be an ACF regeneration valve for dosing fuel vapors.

EP 0 754 269 B1 discloses similar valves, which are used as ACF valves in motor vehicles. Such valves control the gasoline vapors coming from the tank or from an active carbon filter of the tank venting.

Hydrocarbons evaporate in the tank of the motor vehicle, which is driven by an Otto-cycle engine. In order to avoid a pressure increase in the fuel tank, it is necessary to disperse excess air and fuel vapors into the environment. The fuel vapors may be stored in an active carbon tank (ACF), where hydrocarbons are absorbed.

In order to clean the active carbon container, the hydrocarbons may be periodically redrawn from the active carbon container by setting adequate pressure conditions, and then be fed to the combustion together with the intake air.

In order to dose the hydrocarbons in the intake air, a valve of the present kind may be used, since it operates in a relatively temperature-independent way and therefore in a very precise and reproducible way.

Valve a preferably provided with linear drives.

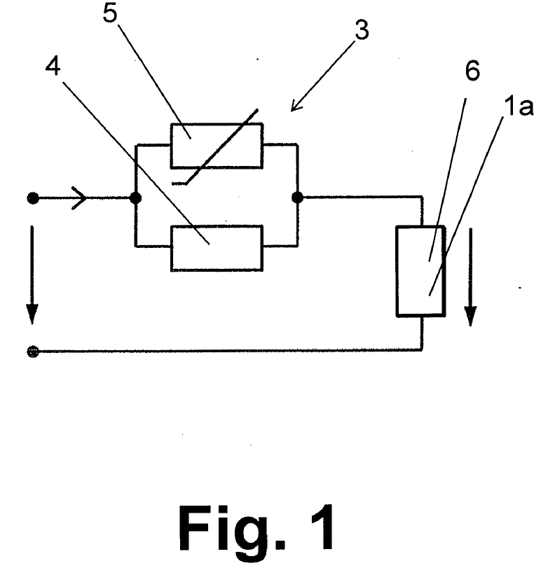

FIG. 1 shows a circuit to be used in an actuator, electromotive drive or valve, comprising an electric conductor 1a with a temperature-dependent electric resistor 6, which is series-connected with an electric series resistor 3.

The electric series resistor 3 comprises a parallel circuit formed by a non-reactive resistor 4 and an NTC-resistor 5.

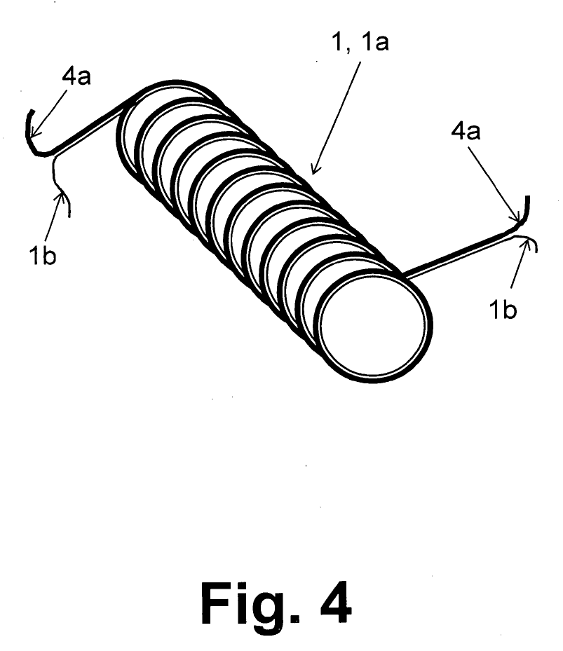

The non-reactive resistor 4 is exclusively or predominantly formed by a wire 4a, which is shown in FIG. 4.

The electric conductor 1a is provided with a copper wire 1b. The copper wire 1b is wound and part of an electromagnetic coil 1.

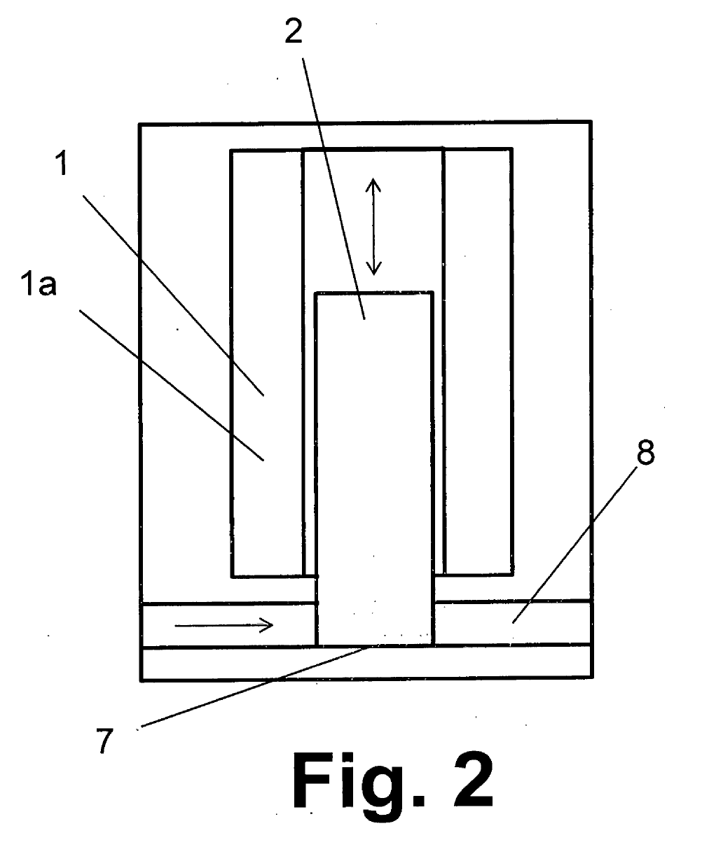

FIG. 1 shows an equivalent circuit for use in actuators, electromotive drives or valves, which are used in a valve according to FIG. 2.

The valve of FIG. 2 comprises as an electric conductor 1a an electromagnetic coil 1. The valve also comprises a rotor 2, wherein the rotor 2 may be driven by the magnetic force of the coil 1, and wherein the coil 1 is series-connected with an electric series resistor 3 according to FIG. 1.

In the equivalent circuit of FIG. 1 it is shown that the electric series resistor 3 is formed by a parallel circuit formed by a non-reactive resistor 4, i.e. a passive electric resistor, and an NTC-resistor 5.

The passive, non-reactive resistor 4 is exclusively or predominantly formed by a wire 4a, which is shown in FIG. 4. The wire 4a exhibits a specific electric resistance, whose value at 600° C. is less than 5% above its value at 20° C. The wire 4a is made of constantan (trade mark).

Concretely, the series resistor 3 is formed by the parallel circuit formed by the non-reactive resistor 4 and the NTC-resistor 5. The electric resistance of the NTC-resistor 5 decreases with an increase in temperature.

Only one coil 1 is provided. A higher number of series-connected coils may also be provided. The only coil 1 is series-connected with the series resistor 3. In the equivalent circuit, coil 1 is represented by its electric resistance 6, i.e. the electric resistance 6 of an electric conductor 1a.

FIG. 2 only schematically shows that the rotor 2 closes or opens a sealing seat 7, in order to allow or inhibit a flow of material through the conduit 8.

The rotor 2 may perform an up-and-down motion. This is shown by the double arrow. Usually, the rotor 2 is pressed by a spring against the sealing seat 7. Through the magnetic force of the electrified coil 1, the rotor 2 is raised against the force of the spring from the sealing seat 7. Once no current flows through the coil 1, the rotor 2 is again pressed by the spring on the sealing seat 7. This procedure may be inverted, and in this case the valve would be a closing instead of an opening device.

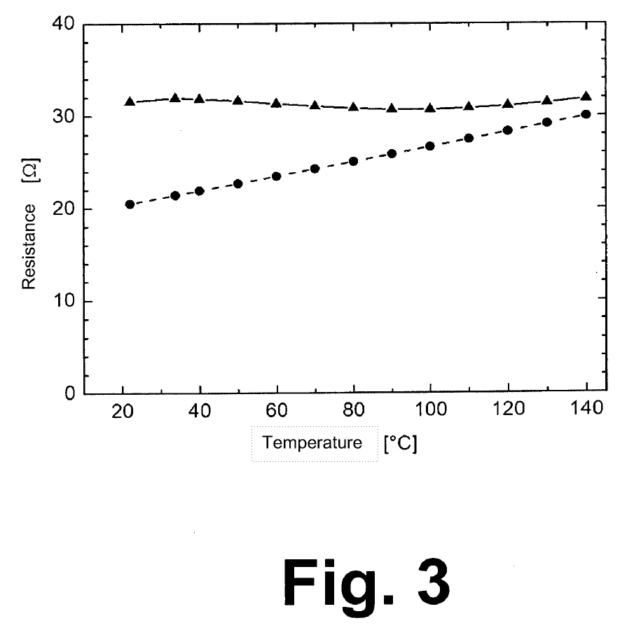

FIG. 3 shows a diagram, in which the temperature dependence of the electric resistance 6 of coil 1 as an electric conductor 1a is represented by circular symbols. When temperature increases so does the uncompensated electric resistance 6 of coil 1 or electric conductor 1a.

In this example, the electric resistance 6 increases by about 50% of its original value in case of a temperature increase from 20° C. to 140° C. The electric resistance 6 of coil 1 increases from about 20 to about 30 ohm.

The temperature compensated electric total resistance, which is formed by the sum of the electric resistance of coil 1 and series resistor 3 of parallel circuit formed by the non-reactive resistor 4 and NTC-resistor 5, is approximately constant in above said temperature range. The temperature compensated total resistance fluctuates only by about a few percentages, preferably a maximum of 2%, about an average value. The average value in this case is about 30 ohm. This is shown by triangular symbols. This value very strongly depends on the temperature range, for which the series resistor 3 is designed.

The series resistance R_{V} of the parallel circuit is calculated according to following formula, wherein R_{Ω} represents the purely non-reactive resistor 4 and R_{NTC} represents the NTC-resistor 5.

$${R}_{V} = \frac{1}{\frac{1}{{R}_{Ω}} + \frac{1}{{R}_{NTC}}}$$

The temperature-compensated total resistance Rₜₒₜₐₗ formed by the parallel circuit and coil 1 is calculated by the following formula, wherein R_{coil} represents the electric resistor 6 of coil 1 or electric conductor 1a.

Rₜₒₜₐₗ=R_{V}+R_{coil}

FIG. 4 shows a schematic illustration of the electromagnetic coil 1 as an electric conductor 1a, which is provided with a wound copper wire 1b.

Besides the copper wire 1b, a wire 4a is wound, which has a specific electric resistance, whose value at 600° C. is less than 5% higher than its value at 20° C. The wire 4a is made of Constantan.

The wire 4a is additionally wound over the electromagnetic coil 1, which, as an electric conductor 1a, forms the temperature-dependent electric resistor 6.

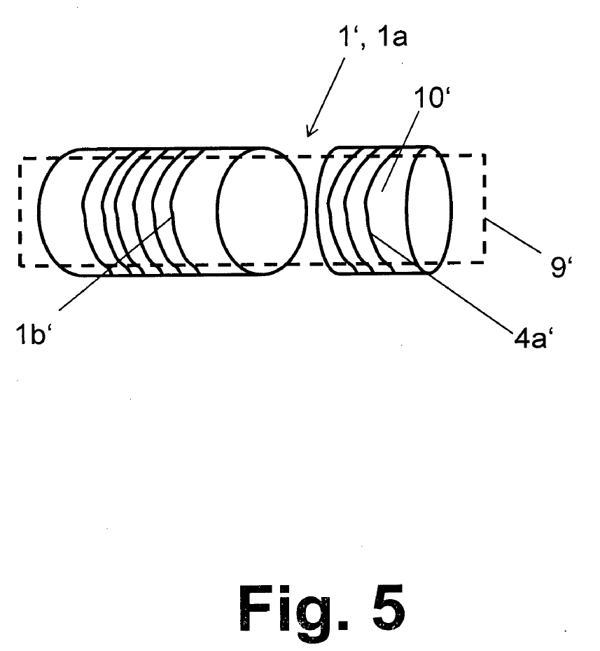

FIG. 5 shows a schematic illustration of an electromagnetic coil 1′ as an electric conductor 1a, which is provided with a wound copper wire 1b′.

Besides the copper wire 1b′, a wire 4a′ is wound, which exhibits a specific electric resistance, whose value at 600° C. is less than 5% higher than its value at 20° C. The wire 4a′ is made of Constantan.

Concretely, in this case, the wire 4a′ is additionally wound on a coil support 9′ of coil 1′, which exhibits as an electric conductor 1a, the temperature-dependent electric resistor 6, wherein the wire 4a′ is positioned in its own winding area 10′.

The coil 1′, which is described with reference to FIG. 5, may obviously be used also in a valve according to FIG. 2 and in the described circuit.

1. A circuit for use in actuators, electromotive drives or valves, comprising:
an electric conductor having a temperature-dependent electric resistance, the electric conductor being series-connected with an electric series resistor, wherein the electric series resistor comprises a parallel circuit which comprises a non-reactive resistor and an NTC resistor, characterized in that wherein the non-reactive resistor is formed exclusively or predominantly by a wire.

2. The circuit according to claim 1, wherein the resistance of the wire at 600° C. is less than 20% of the resistance of the wire at 20° C.

3. The circuit according to claim 1, wherein the wire is made of an alloy comprising copper, nickel and manganese.

4. The circuit according to claim 1, wherein the electric conductor comprises a coil, and wherein the wire is wound on the coil.

5. The circuit according to claim 4, wherein the coil comprises a coil support, and wherein the wire is wound on the coil support in its own winding area.

6. The circuit according to claim 1, wherein the electric conductor comprises a copper wire.

7. A valve, comprising a circuit according to claim 1.

8. The valve according to claim 7, wherein the electric conductor comprises an electromagnetic coil, and wherein the valve further comprises a rotor that moves when electricity is provided to the electromagnetic coil.

9. The valve according to claim 8, wherein the only coil in the electric conductor is the electromagnetic coil.

10. The valve according to claim 7, wherein the valve is an ACF-regeneration valve for dosing of fuel vapors.

11. The circuit according to claim 2, wherein the resistance of the wire at 600° C. is less than 10% of the resistance of the wire at 20° C.

12. The circuit according to claim 11, wherein the resistance of the wire at 600° C. is less than 5% of the resistance of the wire at 20° C.

13. The circuit according to claim 5, wherein the coil further comprises a copper wire wound on the coil support.

14. The circuit according to claim 13, wherein the wire is located on an area of the coil support separate from the copper wire.

15. The circuit according to claim 14, wherein the wire is comprised of an alloy comprising copper, nickel and manganese.

16. The circuit according to claim 15, wherein the resistance of the wire at 600° C. is less than 20% of the resistance of the wire at 20° C.
